(19) United States
(12) Patent Application Publication
(10) Pub. No.: US 2009/0119745 A1
(43) Pub. Date: May 7, 2009

(54) SYSTEM AND METHOD FOR PREVENTING PRIVATE INFORMATION FROM LEAKING OUT THROUGH ACCESS CONTEXT ANALYSIS IN PERSONAL MOBILE TERMINAL

(76) Inventors: Boheung CHUNG, Daejeon-city (KR); Youngho KIM, Daejeon-city (KR); Kwangho BAIK, Daejeon-city (KR); Kiyoung KIM, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/168,989

(22) Filed: Jul. 8, 2008

(30) Foreign Application Priority Data
Nov. 5, 2007 (KR) 10-2007-0111879

(51) Int. Cl. H04L 9/00

(52) U.S. Cl. 726/1

(57) ABSTRACT

A system for preventing private information from leaking out through access context analysis in a personal mobile terminal includes a private information manager that receives a private information leakage prevention policy, divides the policy into a plurality of private information leakage prevention rules, and transmits the plurality of rules to individual modules, respectively; a context analyzer that performs access context information analysis to obtain context information, when detecting a packet corresponding to a first rule, and transmits the context information; a packet analyzer that receives the context information, monitors packets transmitted to the outside through packet analysis, and transmits filtering information when detecting a packet corresponding to a second rule; and a private information leakage preventing unit that receives the filtering information and determines whether to allow or drop a packet corresponding to a third rule.

### BACKGROUND OF THE INVENTION

1. Field of the Invention

The present invention relates to a system and method for preventing private information from leaking out, and in particular, to a system and method for preventing private information from leaking out through access context analysis in a personal mobile terminal, which can set private information leakage prevention rules in the terminal and prevent private information stored in the terminal from illegally leaking out according to the set rules through access context analysis with respect to resources (for example, files and processes) existing in the terminal and network-based packet analysis.

This work was supported by the IT R&D program of MIC/IITA [2007-S-023-01, Development of the threat containment for all-in-one mobile devices on convergence networks].

2. Description of the Related Art

In general, information systems are required to detect and prevent an ARP redirect attack and an ARP spoofing attack in order to protect internal information resources and increase network security.

FIG. 1 is a diagram illustrating the configuration of a system that stops a detected internal information leaking node off from searching a network by ARP spoofing according to the related art.

A network manager may detect and prevent information leakage from a network including a server 20 through the Internet using a web client 10. The server 20 that detects information leakage through ARP spoofing finds out an information leakage node 30 connected to the Internet and performs ARP spoofing on that node.

The server 20 transmits an ARP packet to the information leakage node 30, thereby making the information leakage node 30 recognize the server 20 as a router. Then, the information leakage node 30 transmits all packets through the server 20. The server 20 analyzes the packets transmitted from the information leakage node 30 to determine whether any stolen information exists. In order to block the node, the server regularly transmits an ARP request packet to the IP address of the node until a program is shut down, to make the node recognize a local IP address as a router thereof, and to drop all packets.

Recently, with the development of information communication and ubiquitous computing techniques, personal mobile terminals have increased, such as mobile communication terminals, PDAs, PMPs, and handheld PCs, which easily and conveniently provide various multimedia application services over networks including mobile communications networks and portable Internet networks. However, personal mobile terminals have security weakness in comparison to systems, such as PCs, serving as hosts and thus private file information may easily leak out. In order to prevent information from leaking out of personal mobile terminals, users of the personal mobile terminals use a simple method to protect a system, for example, a method to protect a system using personal identification numbers, to protect information resources of the terminals.

However, in these cases, protecting the information on personal mobile terminals has limitations because of the following reasons.

First, in general personal mobile terminals, the classifying and controlling of information on individual users on the basis of importance is difficult. An access control function sets only access right to resources (for example, files and processes) of a user. However, it is difficult to discriminate between private information that should not be leaked out and public information that can be leaked out, among information of individual users. For example, a file including “certificate information” among files stored in a personal user terminal should not be leaked to external networks. However, there are not existing control methods of preventing the file from leaking out.

Second, general personal mobile terminals cannot perform delicate access control with respect to a plurality of users who can access the same resources. In other words, a file F may be accessible to two users A and B. If the file F includes private information of the user A, the file F should not leaked by the user B. However, in general mobile terminals, it is difficult to prevent the file F including the private information of the user A from being leaked by another user.

Third, in general personal mobile terminals, it is difficult to perform delicate control on private information of users. In other words, assuming that private information of a user A is stored in a file F, even if it is required that the file information is accessible to a host having an IP address of 10.1.1.1, but is not accessible to another host having an IP address of 10.1.1.2, the general personal mobile terminals cannot prevent specific files from leaking out.

### SUMMARY OF THE INVENTION

Accordingly, the present invention has been made to solve the above-described problems in the related art, and it is an object of the present invention to provide a system and method for preventing private information from leaking out through access context analysis in a personal mobile terminal, which sets private information leakage prevention rules including functional conjunction methods and detection conditions in the terminal and which effectively prevents private information of a user in the terminal from illegally leaking out through a network interface according to the set rules through analysis of access context with respect to resources (for example, files and processes) in the terminal and network-based packet analysis.

In order to achieve the object of the present invention, according to an aspect of the present invention, there is provided a system for preventing private information from leaking out through access context analysis in a personal mobile terminal. The system includes a private information manager that receives a private information leakage prevention policy and divides the private information leakage prevention policy into a plurality of private information leakage prevention rules including first, second, and third rules; a context analyzer that performs access context information analysis to obtain context information, when detecting a packet corresponding to the first rule received from the private information manager, and transits the context information; a packet analyzer that receives the context information from the context analyzer, monitors packets transmitted to the outside through packet analysis, and transmits filtering information when detecting a packet corresponding to the second rule received from the private information manager; and a private information leakage preventing unit that receives the filtering information from the packet analyzer and determines dropping a packet corresponding to the third rule received from the private information manager.

The context information may include at least one of user information, information on accessed files, and port information.

The packet analyzer may determine whether a source port field value of the packet is the same as a source port value of the port information included in the context information.

When the source port field value of the packet is the same as the source port value of the port information included in the context information and a destination IP address field value of the packet is the same as a destination IP address value set in the second rule, the packet analyzer may transmit the filtering information to the private information leakage preventing unit.

The private information manager may divide the input private information leakage prevention policy into the first rule regarding a user and a file, the second rule regarding a destination IP address, and the third rule regarding the user, the file, and the destination IP address, and transmit the first, second, and third rules to the context analyzer, the packet analyzer, and the private information leakage preventing unit, respectively.

The third rule received by the private information leakage preventing unit may include access control information with respect to resources existing in the personal mobile terminal.

The context analyzer may be activated when access to resources existing in the personal mobile terminal is started.

According to another aspect of the present invention, there is provided a method of preventing private information from leaking out through access context analysis in a personal mobile terminal. The method includes allowing a private information manager to receive a private information leakage prevention policy, to divide the private information leakage prevention policy into a plurality of private information leakage prevention rules including first, second, and third rules, and to transmit the first, second, and third rules to a context analyzer, a packet analyzer, and a private information leakage preventing unit, respectively; allowing the context analyzer to transmit context information to the packet analyzer when detecting a packet corresponding to the first rule and to activate the packet analyzer; allowing the packet analyzer to transmit filtering information to the private information leakage preventing unit when detecting a packet corresponding to the second rule, and to activate the private information leakage preventing unit; and allowing the private information leakage preventing unit to drop a packet corresponding to the third rule.

The context information may include port information, and the allowing of the packet analyzer to transmit the filtering information to the private information leakage preventing unit may include determining whether a source port field value of the packet is the same as a source port value of the port information included in the context information.

The allowing of the packet analyzer to transmit the filtering information to the private information leakage preventing unit may include, when it is determined that the source port field value of the packet is the same as the source port value of the port information included in the context information and a destination IP address field value of the packet is the same as a destination IP address value set in the second rule, transmitting the filtering information to the private information leakage preventing unit.

The third rule may include access control information with respect to resources existing in the personal mobile terminal.

The allowing of the context analyzer to transmit the context information to the packet analyzer may be activated when access to resources existing in the personal mobile terminal is started.

As described above, in the system for preventing private information from leaking out in a personal mobile terminal, the private information manager divides the private information leakage prevention policy including detection conditions set by a manager into the private information leakage prevention rules, and transmits the private information leakage prevention rules to the context analyzer, the packet analyzer, and the private information leakage preventing unit, respectively. Access context analysis and packet analysis are performed according to the set rules to allow or drop private information of the user transmitted to the outside of the terminal. The system does not check all packets transmitted to the outside but only a minimal quantity of packets, thereby preventing private information from leaking out of the terminal.

Further, a system for preventing private information from leaking out according to an embodiment of the present invention operates based on software, timely detects a private information leakage time point, and prevents information leakage at minimum costs. Therefore, the system can be applied to a personal mobile terminal which should have a low power consumption property to prevent private information from leaking out.

### BRIEF DESCRIPTION OF THE DRAWINGS

FIG. 1 is a diagram illustrating the configuration of a system that stops a detected internal information leaking node off from searching a network by ARP spoofing according to the related art;

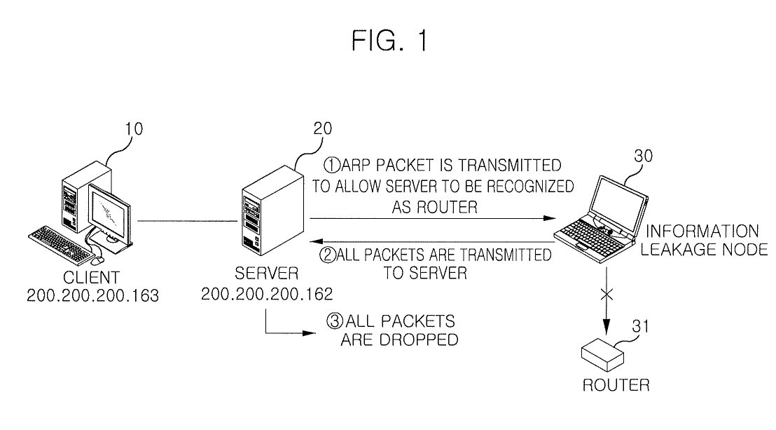

FIG. 2 is a diagram illustrating the configuration of a system for preventing private information of a user from leaking out through access context analysis in a personal mobile terminal according to an embodiment of the present invention;

FIG. 3 is a conceptual diagram illustrating a process of preventing private information from leaking according to a set private information leakage prevention policy in a personal mobile terminal according to an embodiment of the present invention; and

FIG. 4 is a flowchart illustrating a method of preventing private information of a user from leaking out through access context analysis in a personal mobile terminal according to an embodiment of the present invention.

### DESCRIPTION OF THE PREFERRED EMBODIMENTS

Preferred embodiments of the present invention will now be described in detail with reference to the accompany drawings.

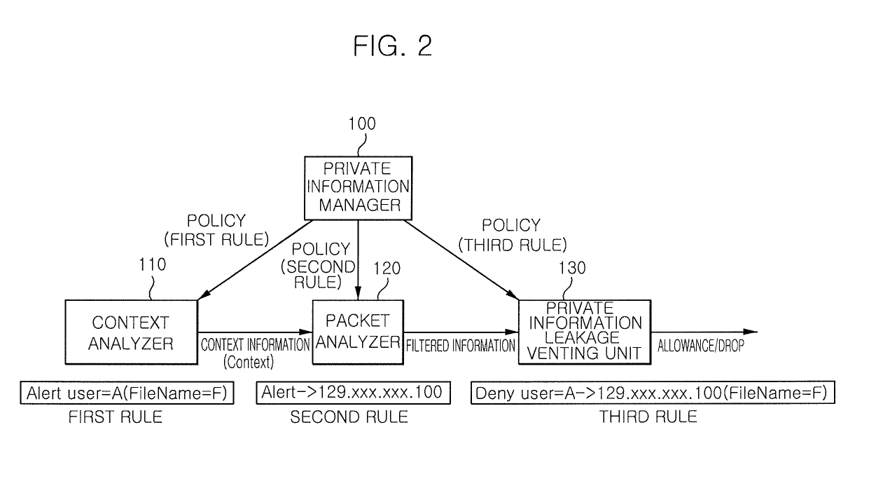

FIG. 2 is a diagram illustrating the configuration of a system for preventing private information of a user from leaking out through access context analysis and packet analysis in a personal mobile terminal according to an embodiment of the present invention.

A system for preventing private information of a user from leaking out through access context analysis in a personal mobile terminal includes a private information manager 100, a context analyzer 110, a packet analyzer 120, and a private information leakage preventing unit 130.

Examples of the personal mobile terminal include computers, notebook computers, mobile communication terminals, PDAs, PMPs, handheld PCs, and mobile Internet terminals.

In a personal mobile terminal, a private information leakage prevention policy that a user sets by using an application program is transmitted to the private information manager 100. The private information manager 100 divides the private information leakage prevention policy into a plurality of private information leakage prevention rules including a first rule, a second rule, and a third rule. Then, the private information manager 100 applies the first, second, and third rules to the context analyzer 110, the packet analyzer 120, and the private information leakage preventing unit 130, respectively.

In other words, the private information leakage prevention policy is stored in a safe storage of the terminal. If the user logs into the terminal, the private information manager 100 divides the policy into the plurality of private information leakage prevention rules including the first, second, and third rules, and applies the first, second, and third rules to the context analyzer 110, the packet analyzer 120, and the private information leakage preventing unit 130, respectively. If the user logs out, the application of the private information leakage prevention policy in each module is released.

The private information leakage prevention policy will be described below in a generic and descriptive sense only and not for purposes of limitation. For example, if a manager set the private information leakage prevention policy to “Prevent the activity of User A, send file F to a host having an IP address of 129.xxx.xxx.100”, the private information leakage prevention policy is converted into a text-based rule, “drop user=A to 129.xxx.xxx.100 (FileName=F)” by the application program, and the text-based rule is transmitted to the private information manager 100.

The private information manager 100 receives information on the private information leakage prevention policy set by the user from the application program, and divides the private information leakage prevention policy into the first rule regarding a user and a file (“Alert user=A (FileName=F)”), the second rule regarding a destination IP address (“Alert−>129.xxx.xxx.100”), and the third rule regarding the user, the file, and the destination IP address (“Deny user=A−>129.xxx.xxx.100 (FileName=F)”).

The third rule includes access control information regarding the resources (for example, files and processes) existing in the personal mobile terminal.

The user uses the application program for private information leakage prevention to set the private information leakage prevention policy with respect to the resources (for example, files and processes) existing in the terminal, and the private information manager 100 divides the private information leakage prevention policy to set the private information leakage prevention rules (first, second, and third rules).

The private information manager 100 assigns the private information leakage prevention rules (first, second, and third rules) to the context analyzer 110, the packet analyzer 120, and the private information leakage preventing unit 130, respectively. In other words, the private information manager 100 divides the private information leakage prevention policy into the private information leakage prevention rules (first, second, and third rules), and transmits the first rule to the context analyzer 110, the second rule to the packet analyzer 120, and the third rule to the private information leakage preventing unit 130.

The context analyzer 110 monitors the activities of the user A on the basis of the first rule. If the user A accesses the file F (If the context analyzer 110 detects any packet corresponding to the first rule), the context analyzer 110 performs access context information analyzing to obtain context information and transmits the context information to the packet analyzer 120.

The packet analyzer 120 receives the context information from the context analyzer 110, and monitors and analyzes packets transmitted from the outside. In the case where a source port (hereinafter, referred to as SP) value of any of those packets is determined to be the same as a SP value of port information included in the context information, if the IP address field value of the determined packet is the same as the destination IP address value (for example, 129.xxx.xxx.100) set in the second rule, the packet analyzer 120 transmits filtering information to the private information leakage preventing unit 130.

The private information leakage preventing unit 130 determines whether to allow or drop the corresponding packet on the basis of the third rule assigned by the private information manager 100.

A system for preventing private information from leaking out in a personal mobile terminal according to an embodiment of the present invention dynamically checks packets transmitted to the outside of the terminal not always but during only a period from a time point when access to resources (for example, files and processes) in the terminal starts to a time point when the access to the resources in the terminal ends.

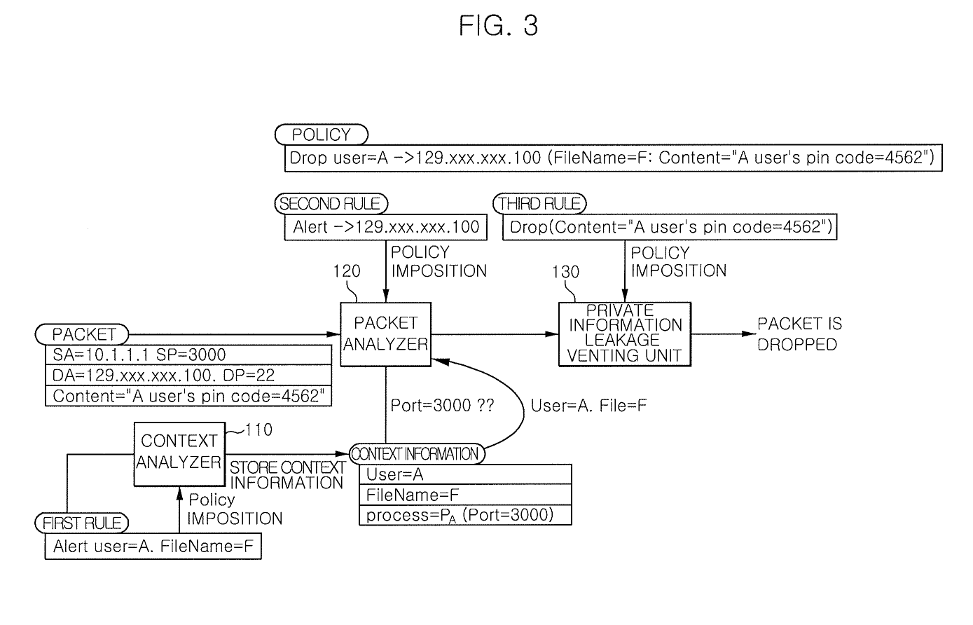

FIG. 3 is a conceptual diagram illustrating a process of preventing private information from leaking according to a set private information leakage prevention policy in a personal mobile terminal according to an embodiment of the present invention.

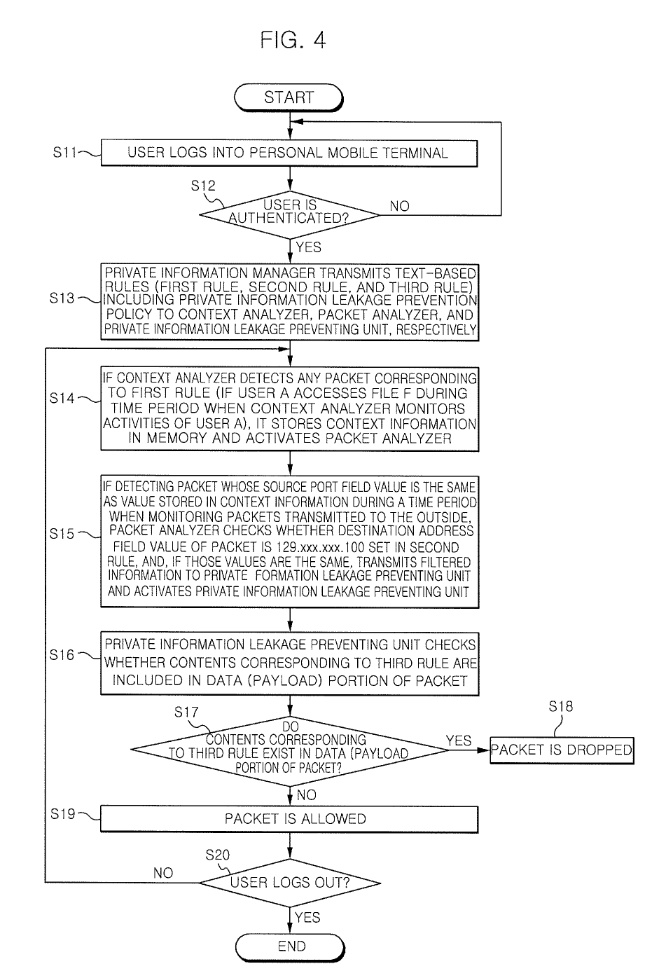

FIG. 4 is a flowchart illustrating a method of preventing private information of a user from leaking out through access context analysis in a personal mobile terminal according to an embodiment of the present invention.

A user of a personal mobile terminal performs login with private information leakage prevention service ID and pin code through an application program (S11). Then, the user of the personal mobile terminal is authenticated (S12).

For example, the terminal user uses the application program for private information leakage prevention to set a private information leakage prevention policy, such as “Drop user=A−>129.xxx.xxx.100 (FileName=F; Content=“A user's pin code=4562””).

The private information manager 100 divides the set private information leakage prevention policy into the first rule (“Alert user=A, FileName=F”), the second rule (“Alert−>129.xxx.xxx.100”), and the third rule (“Drop (Content=“A user's in code=4562”)”), and assigns the divided rules (first, second, and third rules) to the context analyzer 110, the packet analyzer 120, and the private information leakage preventing unit 130, respectively (S13).

The context analyzer 110 monitors the activities of the user A on the basis of the set first rule. If the user A accesses the file F (If any packet corresponding to the first rule is detected), the context analyzer 110 stores access context information in a memory and activates the packet analyzer 120 (S14).

The context information includes user information, information on an accessed file, and information on a process used for accessing (information on a port opened for packet transmission to the outside).

Next, the packet analyzer 120 monitors packets transmitted to the outside on the basis of the second rule. If detecting any packet whose SP field value is the same as a port number 3000 of a process stored in the context information, the packet analyzer 120 checks whether a DA (destination address) field value of the detected packet is 129.xxx.xxx.100 (destination IP address) set in the second rule. If the two values are the same, the packet analyzer 120 transmits the filtering information to the private information leakage preventing unit 130 so as to activate the private information leakage preventing unit 130 (S15).

Finally, the private information leakage preventing unit 130 checks whether any content corresponding to the third rule is included in the data (payload) portion of the packet (S16). If any packet corresponding to the third rule exists (S17), the private information leakage preventing unit 130 drops all packets regarding the corresponding file (S18).

If any packet corresponding to the third rule does not exist, the private information leakage preventing unit 130 allows all packets regarding the corresponding file (S19).

If the user logs out, the personal mobile terminal releases the application of the private information leakage prevention policy to the private information manager 100, the context analyzer 110, the packet analyzer 120, and the private information leakage preventing unit 130 (S20).

In the drawings and specification, there have been disclosed typical embodiments of the present invention and, although specific terms are employed, they are used in a generic and descriptive sense only and not for purposes of limitation. It will be apparent to those skilled in the art that modifications and variations can be made in the present invention without deviating from the spirit or scope of the present invention. Thus, it is intended that the present invention cover any such modifications and variations of this invention provided they come within the scope of the appended claims and their equivalents.

What is claimed is:

1. A system for preventing private information from leaking out through access context analysis in a personal mobile terminal, the system comprising:
a private information manager that receives a private information leakage prevention policy and divides the private information leakage prevention policy into a plurality of private information leakage prevention rules including first, second, and third rules;
a context analyzer that performs access context information analysis to obtain context information, when detecting a packet corresponding to the first rule received from the private information manager, and transmits the context information;
a packet analyzer that receives the context information from the context analyzer, monitors packets transmitted to the outside through packet analysis, and transmits filtering information when detecting a packet corresponding to the second rule received from the private information manager; and
a private information leakage preventing unit that receives the filtering information from the packet analyzer and determines to drop a packet corresponding to the third rule received from the private information manager.

2. The system according to claim 1,
wherein the context information includes at least one of user information, information on accessed files, and port information.

3. The system according to claim 2,
wherein the packet analyzer determines whether a source port field value of the packet is the same as a source port value of the port information included in the context information.

4. The system according to claim 3,
wherein, when the source port field value of the packet is the same as the source port value of the port information included in the context information and a destination IP address field value of the packet is the same as a destination IP address value set in the second rule, the packet analyzer transmits the filtering information to the private information leakage preventing unit.

5. The system according to claim 1,
wherein the private information manager divides the private information leakage prevention policy into the first rule regarding a user and a file, the second rule regarding a destination IP address, and the third rule regarding the user, the file, and the destination IP address, and transmits the first, second, and third rules to the context analyzer, the packet analyzer, and the private information leakage preventing unit, respectively.

6. The system according to claim 1,
wherein the third rule received by the private information leakage preventing unit includes access control information with respect to resources existing in the personal mobile terminal.

7. The system according to claim 1,
wherein the context analyzer is activated when the access to resources existing in the personal mobile terminal is started.

8. A method of preventing private information from leaking out through access context analysis in a personal mobile terminal, the method comprising:
allowing a private information manager to receive a private information leakage prevention policy, to divide the private information leakage prevention policy into a plurality of private information leakage prevention rules including first, second, and third rules, and to transmit the first, second, and third rules to a context analyzer, a packet analyzer, and a private information leakage preventing unit, respectively;
allowing the context analyzer to transmit context information to the packet analyzer when detecting a packet corresponding to the first rule and to activate the packet analyzer;
allowing the packet analyzer to transmit filtering information to the private information leakage preventing unit when detecting a packet corresponding to the second rule, and to activate the private information leakage preventing unit; and
allowing the private information leakage preventing unit to drop a packet corresponding to the third rule.

9. The method according to claim 8,
wherein the context information includes port information, and
the allowing of the packet analyzer to transmit the filtering information to the private information leakage preventing unit includes:
determining whether a source port field value of the packet is the same as a source port value of the port information included in the context information; and
transmitting the filtering information to the private information leakage preventing unit when it is determined that the source port field value of the packet is the same as the source port value of the port information included in the context information and a destination IP address field value of the packet is the same as a destination IP address value set in the second rule.

10. The method according to claim 8,
wherein the third rule includes access control information with respect to resources existing in the personal mobile terminal.

11. The method according to claim 8,
wherein the allowing of the context analyzer to transmit the context information to the packet analyzer is activated when the access to resources existing in the personal mobile terminal is started.
